(19) United States
(12) Patent Application Publication
(10) Pub. No.: US 2011/0134441 A1
(43) Pub. Date: Jun. 9, 2011

(54) SYSTEM AND METHOD FOR CUSTOMIZING AND PRINTING CUSTOM DESIGNED STICKERS

(75) Inventor: Michael Barker, Portsmouth, NH (US)

(73) Assignee: Momenta, Inc., Northwood, NH (US)

(21) Appl. No.: 12/959,679

(22) Filed: Dec. 3, 2010

Related U.S. Application Data
(60) Provisional application No. 61/266,250, filed on Dec. 3, 2009.

(51) Int. Cl. G06F 3/12; B41F 33/00

(52) U.S. Cl. 358/1.1; 101/484

(57) ABSTRACT

A system and method for customizing and printing custom designed stickers allows a user to select almost unlimited designs (e.g., colors, patterns, artwork, photographs) and to print the selected designs on a blank sticker sheet. The system and method thus allows a retail store to stock blank sticker sheets, avoids the inefficiencies of having to stock stickers with a wide variety of unique colors and patterns, and allows a user to create stickers with a user created design. Although the exemplary embodiments show alphabet stickers, the system and method may be used to custom design and print any type of sticker including, without limitation, message stickers, frame stickers and icon stickers.

### CROSS-REFERENCE TO RELATED APPLICATION

The present application claims the benefit of U.S. Provisional Patent Application Ser. No. 61/266,250 filed Dec. 3, 2009, which is incorporated herein by reference.

### TECHNICAL FIELD

The present invention relates to customizing decorative products and more particularly, to a system and method for customizing and printing custom designed stickers.

### BACKGROUND INFORMATION

Brick and mortar retail stores often have limited shelf space for certain types of products that may be available in a wide variety of different designs. Stickers, for example, may come in a variety of different shapes and different colors or patterns. Alphabet stickers, in particular, may have a variety of different fonts, sizes, colors and patterns. The retail stores, such as arts and craft stores, that sell these stickers usually want to offer a wide variety of different designs, which requires the retailer to invest in additional inventory. The stickers are conventionally preprinted and delivered to the store ready for use by the consumer. The limited shelf space in the brick and mortar retail stores limits the selection, however, and consumers may not be able to find a particular color or pattern. Although the retailers try to stock the most popular fonts, sizes and colors in the stores, some consumers are still prevented from finding unique colors or patterns.

Moreover, the retailers usually need to invest more in inventory to stock a wider variety of colors and patterns. If unique stickers with certain colors or patterns do not sell, the retailer may be forced to liquidate for a loss. Thus, retailers may be required to make large initial investments in preprinted stickers to satisfy relatively few customers looking for unique designs, which is an inefficient use of capital.

### BRIEF DESCRIPTION OF THE DRAWINGS

These and other features and advantages will be better understood by reading the following detailed description, taken together with the drawings wherein:

FIG. 1 is a diagrammatic view of a system for customizing and printing custom designed stickers, consistent with an embodiment.

FIG. 2 is a schematic illustration of a user interface for a sticker design system, consistent with an embodiment.

FIG. 3 is a flow chart illustrating a method of customizing and printing custom designed stickers, consistent with an embodiment.

FIG. 4A is a plan view of a blank sticker sheet.

FIG. 4B is a plan view of the sticker sheet shown in FIG. 4A with custom designs printed on the stickers.

FIGS. 5A-5F are screen shots of web pages implementing the system for customizing and printing custom designed stickers, consistent with an embodiment.

### DETAILED DESCRIPTION

A system and method for customizing and printing custom designed stickers, consistent with embodiments described herein, allows a user to select almost unlimited designs (e.g., colors, patterns, artwork, photographs) and to print the selected designs on a blank sticker sheet. The system and method thus allows a retail store to stock blank sticker sheets, avoids the inefficiencies of having to stock stickers with a wide variety of unique colors and patterns, and allows a user to create stickers with a user created design. Although the exemplary embodiments show alphabet stickers, the system and method may be used to custom design and print any type of sticker with any shape including, without limitation, message stickers, frame stickers, and icon stickers.

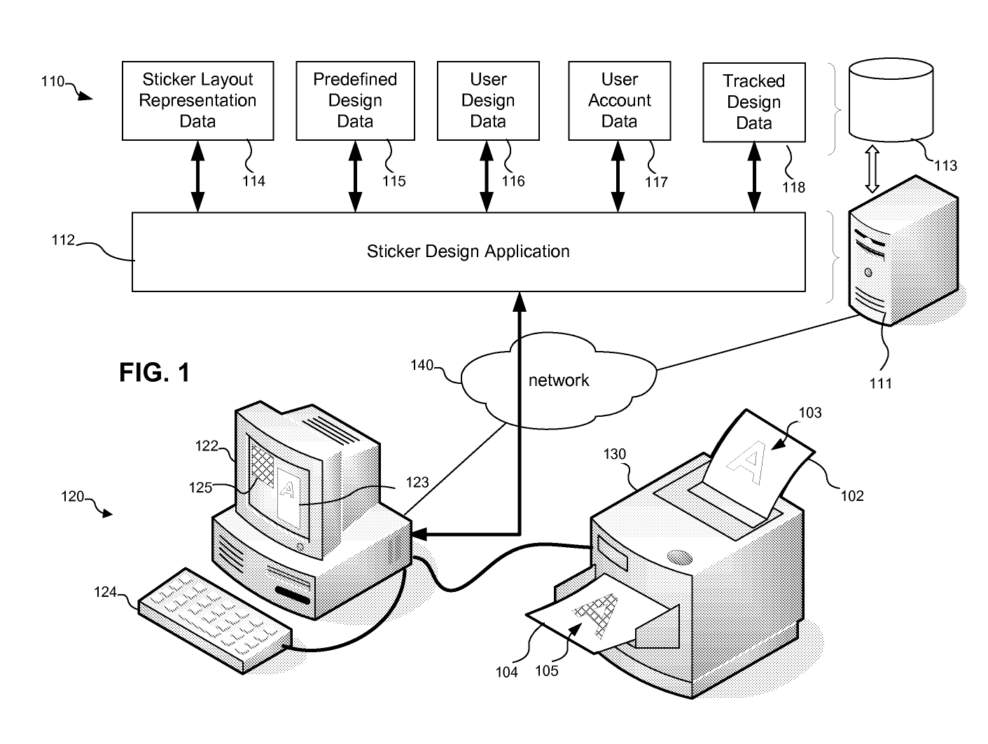

Referring to FIG. 1, a system for custom designing and printing stickers generally includes a computer-implemented sticker design system 110 that is accessible by a computer terminal 120 coupled to a printer 130. In one embodiment, the computer terminal 120 may be a user's desktop or laptop PC or MAC® computer that accesses the sticker design system 110 across a network 140 such as the Internet. In another embodiment, the computer terminal 120 and the printer 130 may be located at a store location, for example, in a kiosk. In yet another embodiment, the sticker design system 110 may be implemented, at least in part, on the computer terminal 120. The computer terminal 120 generally includes one or more computer displays 122 and one or more user input devices 124 such as a keyboard and mouse.

In general, the user accesses the sticker design system 110 using the computer terminal 120 to create a custom design for a sticker sheet and prints the custom design on a blank sticker sheet 102 to generate a custom designed sticker sheet 104. The blank sticker sheet 102 may be obtained at a store location and may include a predefined sticker layout including one or more pre-cut stickers 103. The blank sticker sheet 102 may be white or have some other light color or minimal pattern that allows a design to be added. The computer terminal 120 may be used to locate and display a sticker layout representation 123, which is a graphic representation of the predefined layout of pre-cut stickers 103 on the blank sticker sheet 102. The computer terminal 120 may display the sticker layout representation 123 together with one or more predefined designs 125 (e.g., colors, patterns, artwork, photographs, or any combination thereof), which may be superimposed on the sticker layout representation 123. Using the computer terminal 120, the user may then select one or more of the designs 125 and may cause the selected design(s) to be printed on the blank sticker sheet 102 to produce the custom designed sticker sheet 104.

In one embodiment, an identifier, such as an alphanumeric identifier, may be associated with each predefined sticker layout. The identifiers may be included with the blank sticker sheets obtained at store locations and used to locate the corresponding sticker layout representation 125 to be displayed, for example, by accessing the sticker design system 110.

The sticker design system 110 may include a sticker design application 112 and one or more databases including, for example, sticker layout representation data 114, predefined design data 115, user design data 116, user account data 117, and tracked design data 118. The sticker design application 112 provides the user interface that allows the user to locate and display sticker layout representations, to select designs, to display the selected design(s) on the sticker layout representation(s), and to cause the custom designs to be printed. The sticker design application 112 may also receive user data such as user design data (e.g., an uploaded image) and/or user account data used to establish a user account. The sticker design application 112 may further track the design activities of the users, for example, to determine the most popular designs.

The sticker layout representation data 114 includes the data used to locate and create the sticker layout representations corresponding to the sticker layouts on the blank sticker sheets. The sticker layout representation data 114 may include, for example, image data, such as jpg, gif, bmp, or any other type of image file or data, used to create a graphic representation of the predefined sticker layouts on the blank sticker sheets. The sticker layout representation data 114 may also include the identifiers corresponding to the predefined sticker layouts such that the corresponding sticker layout representations may be located in the database using the identifiers.

The predefined design data 115 includes the data used to create the designs. The predefined design data 115 may include data used to display a full spectrum of colors of different hues and shades. The predefined design data 115 may also include image data, such as jpg, gif, bmp, or any other type of image file or data, used to display an image of a pattern, artwork, photographs, or other designs. The predefined design data 115 may further include image data used to display an image of previously created customized sticker designs.

The user design data 116 includes data representing user designs. The user design data 116 may include, for example, data representing colors, patterns, or artwork uploaded by the user. The user design data 116 may also include data representing combinations of predefined colors, patterns and/or artwork from previous customized designs created by the user. The user design data 116 may further include data representing combinations of selected sticker layouts and selected designs from previous customized designs created by the user.

The user account data 117 includes data representing an account that may be set up by the user. The user account data 117 may include, for example, a user name, password, and user preferences. In some embodiments, the sticker design system 110 may allow a user to order more blank stickers or to order custom designed stickers and the user account data 117 includes user purchasing information such as credit card and address information.

The tracked design data 118 may include design data generated by the users, such as popular sticker layouts and popular designs. The sticker design application 112 may track the data based on the layouts/designs that are created, saved and/or printed by the users and may determine the most popular sticker layouts and/or designs (e.g., the sticker layouts and/or designs with the most print commands executed). The popular sticker layouts and/or designs may be recommended to the users by the sticker design application 112 during the design process. The popular sticker layouts and/or designs may also be used to determine which stickers should be printed and mass produced for sale at retail locations, thereby providing a crowd-sourced approach to product design.

The sticker design system 110 may be implemented using a combination of hardware and software. The hardware may generally include a host computer system 111 and a data storage system 113. The software may include code for providing the functionality of the system and may include the data generated by and accessed by the system. In one embodiment, users may access the functionality provided by the sticker design application 112 and the data 114-118 over the network 140 (e.g., the Internet). The software code may be executed, for example, to interact with the users (e.g., by displaying web pages) and to perform the processes, procedures and/or functions that enable customizing and printing customized stickers.

The host computer system 111 may be coupled to the network 140 and accessed by the user computer terminal 120 coupled to the network 140, for example, by accessing a web site using a web browser. The host computer system 111 may include one or more server computers such as a web server running a network operating system, such as Microsoft Windows XP Server™, Novell Netware™, or Redhat Linux™. Although the host computer system 111 is shown as a single server unit, the host computer system 111 may include a combination of computers or computing components such as a blade server system. The host computer system 111 may also execute a web server application, such as Microsoft IIS™, Novell Webserver™, or Apache Webserver™, that allows for HTTP (i.e., HyperText Transfer Protocol) access to the computer via the network 140. The sticker design system 110 may also use the Microsoft.NET™ Framework as the overall technology platform. The network 140 may be connected to one or more secondary networks, such as a local area network, a wide area network, or an intranet.

The data storage system 113 may be integrated with or coupled directly to the host computer system 111. The host computer system 111 may also be coupled to a data storage system (not shown) accessible over the network 140 in addition to or instead of the data storage system 113. The data storage system 113 may include, for example, one or more hard disk drives, tape drives, optical drives, RAID arrays, random access memory (RAM) devices, and/or a read-only memory (ROM) devices. A relational database management system, such as Microsoft SQL Server, may be used to manage all or a portion of the data 114-118.

The sticker design application 112 may reside on and may be executed, at least in part, by the host computer system 111. In particular, instruction sets and/or subroutines of the sticker design application 112 may be stored on a tangible computer-readable medium (e.g., a storage device) coupled to or integrated in the computer system 111 and may be executed by one or more processors (not shown) and one or more memory architectures (not shown) incorporated into the host computer system 111.

An Application Service Provider (ASP) may host one or more application components of the sticker design application 112 and the data 114-118. The ASP may thus handle application support and storage of data such as usernames, passwords, and user designs. A web site provider may also host the sticker design application 112 and the data 114-118.

The user computer terminal 120 may access the sticker design application 112 directly through the network 140 or through a secondary network. Users may access the sticker design application 112 using the computer terminal 120 connected to the network 140, for example, by executing a client application such as a web browser (e.g., Microsoft Internet Explorer®, Netscape Navigator®, Firefox®, or Google Chrome®) or a specialized interface. When the client application is a web browser, the sticker design application 120 may be accessed by rendering web pages in the web browser. The computer terminal 120 may be the consumer's PC or MAC® computer, mobile computing device, or tablet computing device, or may be a computer terminal located at a store that supplies the blank sticker sheets.

All or a portion of the sticker design application 112 may also reside on and/or be executed by other computers such as web site provider computers, consumer computers and/or third party computers (e.g., retail store computers). At least a portion of the sticker design application 112, for example, may be executed on the user's PC, for example, as an HTML document, an Active X™ control, a Java™ Applet, JavaScript™ functions, and/or an Adobe™ Flash file or other type of plug-in, as the consumer uses the sticker design application 112. All or a portion of the data 114-118 may also be stored on other storage devices, for example, coupled to web site provider computers, consumer computers and/or third party computers. Although the illustrated embodiment shows the host computer system 111 and the user computer terminal separately, the host computer system 111 and the user computer terminal 120 may be integrated such that the sticker design application 112 may be accessed without using a network (e.g., at a store location or at a user's home).

An administrator may access and administer the sticker design application 112 through a client application, such as a web browser (e.g., Microsoft Internet Explorer®, Netscape Navigator®, Firefox®, or Google Chrome®), or a specialized interface running on an administrative computer that is also connected to the network 140. The administrative computer may be located at the same location as the sticker design application 112 or remotely.

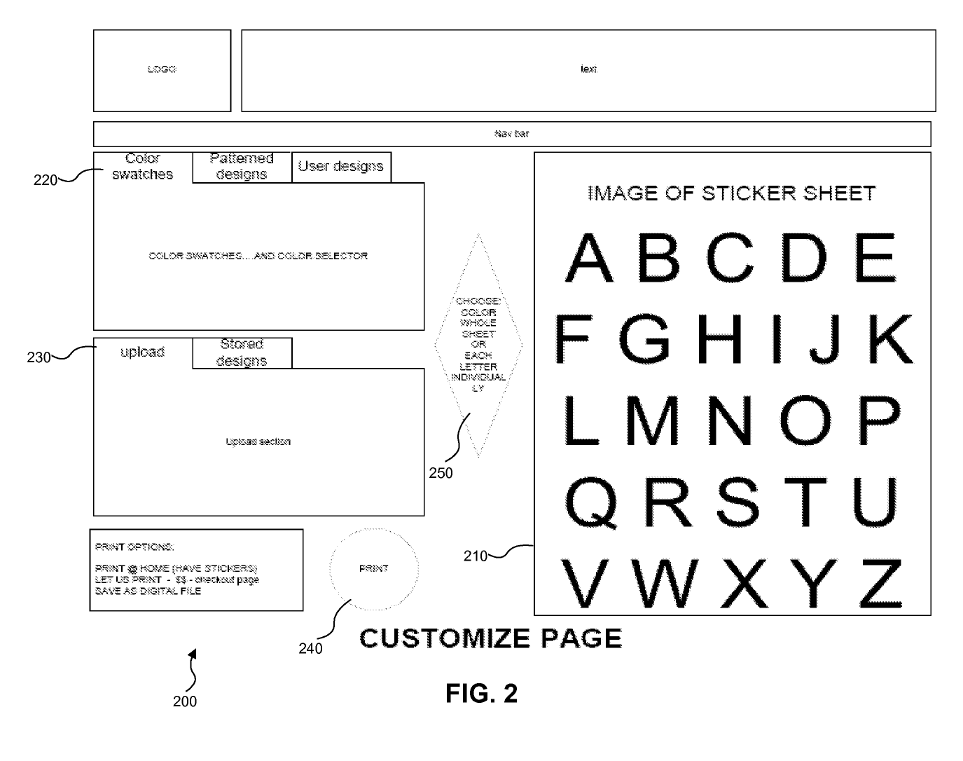

When a user uses a client application to access or interact with the sticker design application 112, the user may be presented with a sticker design screen 200, for example, as shown in FIG. 2, rendered by the client application on the computer terminal 120. Where the client application is a web browser, for example, the sticker design screen 200 may be rendered as a web page in the web browser. The sticker design web page may be accessed via the web site of the store that sold the blank sticker sheet or some other third party web site. The sticker design screen 200 allows the user to interact with the sticker design application 112 to generate one or more custom sticker designs. The custom sticker designs may be generated as new designs or may be generated by loading existing designs.

As shown in FIG. 2, the sticker design screen 200 may include a sticker layout representation 210 corresponding to the predefined layout of a blank sticker sheet to be printed upon. Where the blank sticker sheet includes multiple sheets, the sticker layout representation 210 may include the layout on one or more of the multiple sheets. The sticker layout representation 210 is initially displayed in the same manner as the blank sheet obtained at a store location (e.g., a white sheet is shown initially as white).

The sticker design screen 200 may also include a customized design menu 220 for accessing predefined designs. The predefined designs may include, for example, color swatches, patterned designs, and/or user created designs. The predefined designs may be identified by name and/or by a graphic representation of the predefined design. The customized design menu 220 may further allow the user to select color parameters, such as shade and hue, allowing an almost limitless number of color options for the user.

The sticker design screen 200 may also include an upload section 230 for uploading designs (e.g., colors, patterns, artwork, photographs, or any combination thereof) and for viewing stored uploaded designs. The sticker design screen 200 may further include embedded tools, such as drawing tools, for creating user designed patterns. The sticker design screen 200 may also include a print link or button 240 that allows the user to initiate printing of the selected design(s) on a blank sticker sheet. The user may also select print/save options such as printing at the user location (e.g., to the printer 130 coupled to the computer terminal 120), printing at some remote location for shipping to the user, and/or saving as a digital file. Other user interface features 250 may allow the user to select design preferences. For example, the user may choose to color an entire sheet of stickers or each individual sticker on a sheet. The sticker design screen 200 may further include other common web page features such as a logo, text, and/or a navigation bar.

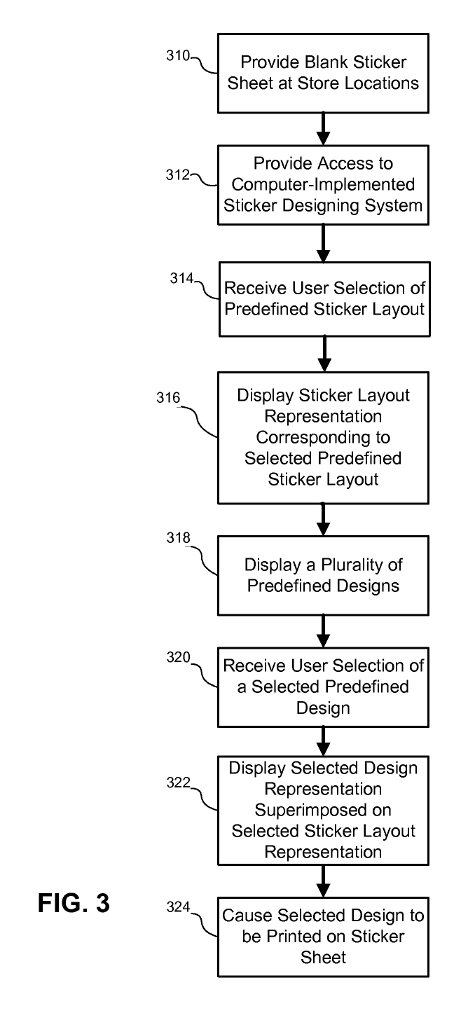

Referring to FIG. 3, one example of a method for customizing and printing custom designed stickers is shown and described. According to this method, blank sticker sheets may be provided 310 at store locations such as retail arts and crafts stores and access is provided 312 to a computer-implemented sticker designing system. The sticker designing system may receive 314 a user selection of a predefined sticker layout of the blank sticker sheet obtained at the store location, and a sticker layout representation for the selected predefined sticker layout may be displayed 316. When the user accesses the sticker designing system and enters an identifier corresponding to the blank sticker sheet, for example, the identifier may be used to retrieve and display the sticker layout representation. A plurality of predefined designs are also displayed 318 allowing the user to select one or more of the designs. The user selection of the selected design(s) is received 320 and a design representation corresponding to the selected design(s) is displayed 322 on the sticker layout representation corresponding to the selected predefined sticker layout. In response to a user print request, the selected design(s) are then caused to be printed 324 on the sticker sheet obtained at the store location.

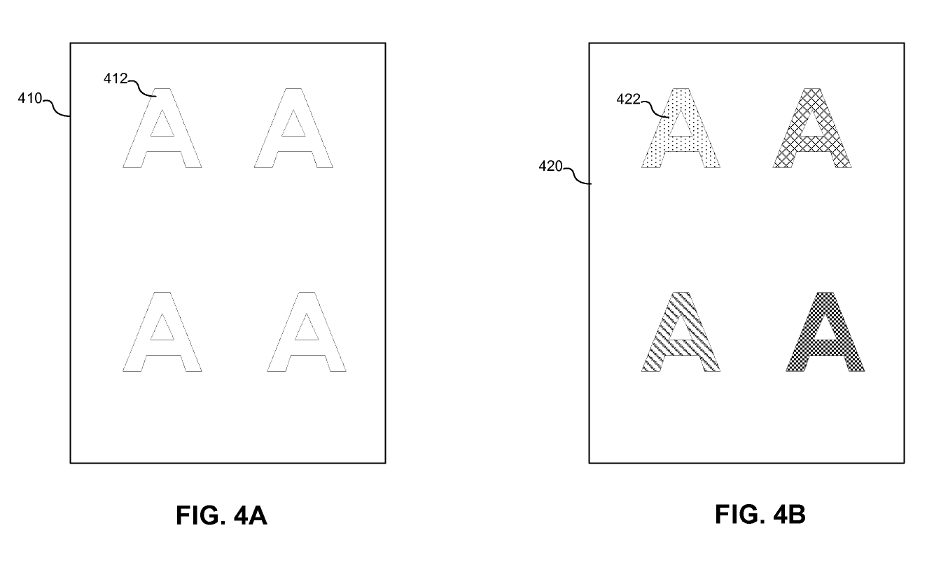

FIGS. 4A and 4B illustrate one example of a blank sticker sheet 410 and a custom designed sticker sheet 420, respectively. In this embodiment, the blank sticker sheet 410 includes a predefined layout including a plurality of pre-cut (e.g., die cut) stickers 412 with a predefined size and shape. Although the illustrated embodiment shows an alphabet sticker sheet with multiple stickers for a single letter have a predefined size and font, the sticker sheet may include any number of different arrangements of alphabet stickers or other types/shapes of stickers. The custom designed sticker sheet 420 includes the pre-cut stickers 422 with the user selected designs printed on the stickers 422. Although the illustrated embodiment shows each of the custom designed stickers 422 with different designs, the user may select a single design for printing on each of the custom designed stickers 422.

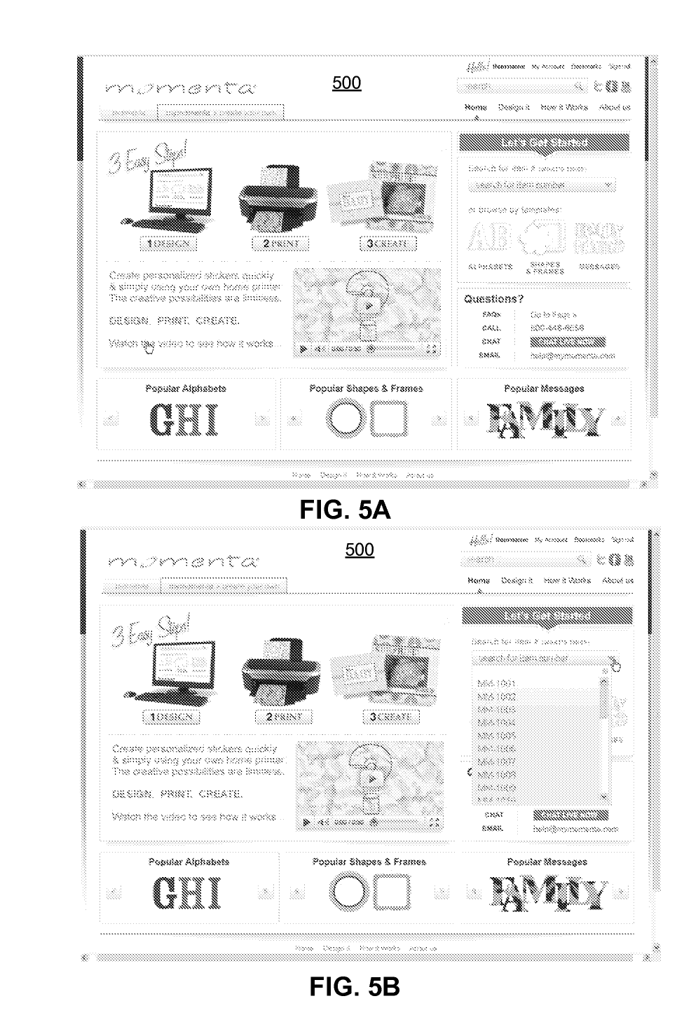

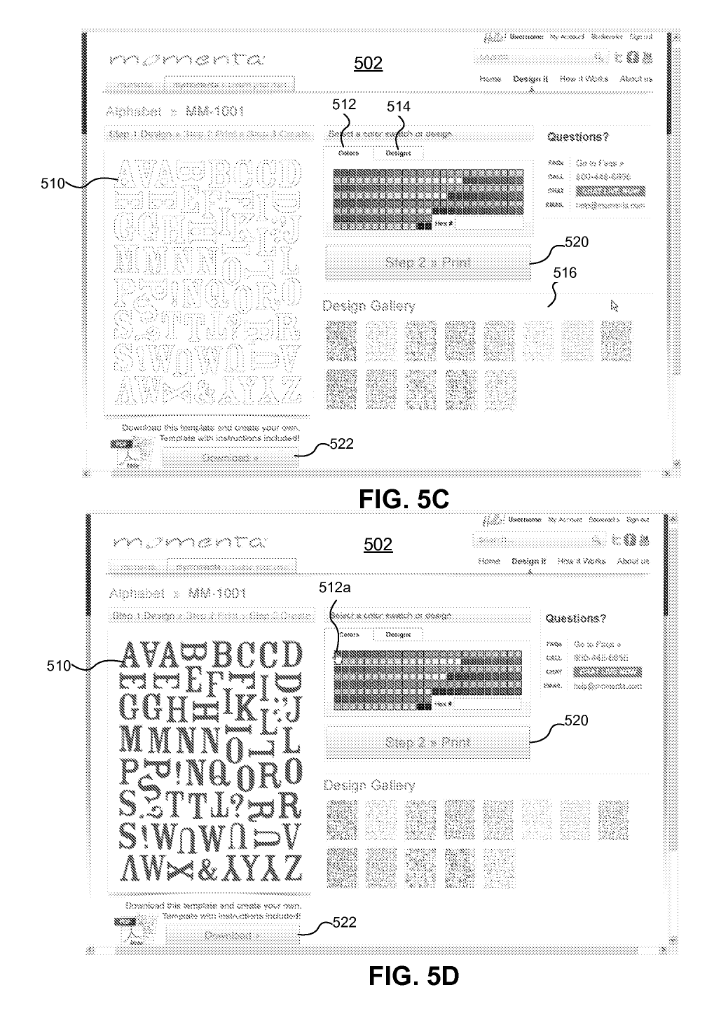

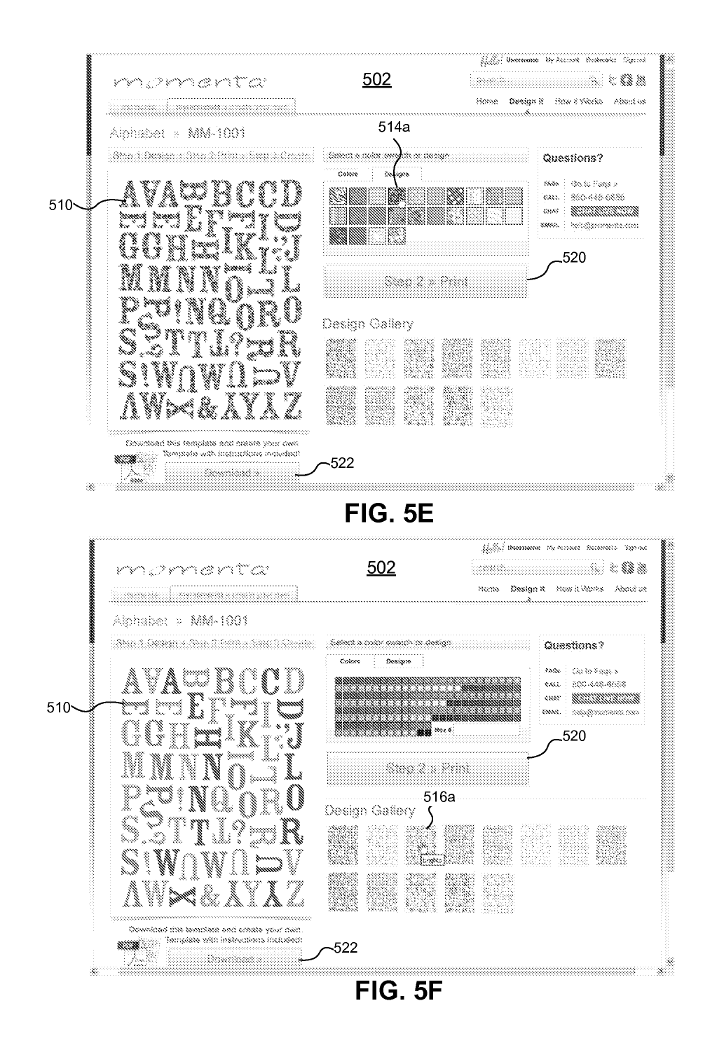

FIGS. 5A-5F illustrate screen shots of exemplary web pages that may be used to implement the sticker design system and method, consistent with an embodiment. As shown in FIG. 5A, a sticker design home page 500 may include graphical user interface (GUI) elements (e.g., drop down menus and hyperlinks) for selecting a sticker sheet layout or template. As shown in FIG. 5B, the sticker sheet layout or template may be selected by an identifier, such as an item number. The sticker sheet layout or template may also be selected by browsing sticker layout representations. The sticker design home page may also include GUI elements for browsing and selecting popular custom designed stickers such as popular alphabets, popular shapes and frames, and popular messages. The popular custom designed stickers may be determined based on the design data tracked for users of the system.

As shown in FIG. 5C, a sticker design page 502 displays a sticker layout representation corresponding to the selected sticker sheet layout 510 together with selectable predefined designs. In the illustrated embodiment, the sticker design page 502 initially displays the sticker layout representation 510 without any color or pattern (e.g., white). The selectable predefined designs may include colors 512 and patterned designs 514 that can be applied (e.g., color swatches and design patterns) to the displayed sticker layout representation. The selectable predefined designs may also include a design gallery 516 including icons representing previously generated customized sticker designs for the displayed sticker layout representation. The design gallery 516 may include, for example, predefined combinations of colors, patterns or other designs applied to different stickers on the sticker layout representation. The colors 512, patterned designs 514, and sticker design icons in the design gallery 516 may appear as hyperlinks on the sticker design page 502. When the user clicks on the hyperlinks, the sticker design page 502 may be updated to show the sticker layout representation with the selected design.

As shown in FIG. 5D, for example, the selection of a color 512a causes the sticker sheet layout representation 510 to be displayed with the selected color. As shown in FIG. 5E, the selection of a design pattern 514a causes the sticker sheet layout representation 510 to be displayed with the selected pattern. As shown in FIG. 5F, the selection of a sticker design icon 516a causes the sticker sheet layout representation 510 to be displayed with the previously created design shown in the sticker design icon 516a. Although the illustrated embodiment shows the selected design being applied to the entire sticker layout representation 510, the sticker design page 502 may also allow the user to apply designs (e.g., colors and/or patterns) to individual stickers on the sticker layout representation to form various combinations of designs.

The sticker design page 510 may also include GUI elements to allow the user to activate other functions, such as printing the design, downloading the design, emailing, and/or sharing the design. As shown in the illustrated embodiment, for example, the sticker design page 502 may include a print activation button 520 and a download activation button 522. Clicking the print activation button 520 may activate a print command directly or may activate another web page and/or function that allows the user to print and/or save the customized sticker design. In one embodiment, clicking the print activation button 520 causes a print web page to be displayed with instructions for printing and/or saving the customized sticker design as a file in an image format such as pdf (portable document file). For example, the print web page may include a button or link to activate a function or process that converts the customized sticker design into a pdf file and opens the pdf file using a browser pdf plug-in such as the Adobe® Reader®. The pdf file is formatted to match the blank sticker sheet corresponding to the sticker layout representation 510 such that printing the pdf file on the blank sticker sheet results in the design(s) being printed in the appropriate locations on the blank sticker sheet.

Clicking on the download activation button 522 on the sticker design page 502 may also cause the customized sticker design to be downloaded, for example, as a pdf file. The sticker design system may also include web pages that allow the users to create projects using the customized stickers. The web pages may include, for example, a project gallery with instructions and templates for creating projects such as customized photo frames. The sticker design system may also allow the user to save the customized sticker designs on-line for printing at a later time. The sticker design system may further allow the user to share the customized sticker designs, for example, by adding the customized sticker designs to an on-line gallery or by email.

Accordingly, a system and method for customizing and printing custom designed stickers allows a user to create a wide variety of designs (e.g., color, patterns, artwork, photographs) for printing on blank sticker sheets.

Consistent with an embodiment, a method is provided for customizing and printing custom designed stickers. The method includes: providing at least one blank sticker sheet at store locations, the blank sticker sheet including at least one pre-cut sticker in a predefined sticker layout; providing access to a computer-implemented sticker designing system on a host computer system, the computer-implemented sticker designing system including a sticker sheet database of sticker layout representations corresponding to a plurality of predefined sticker layouts on blank sticker sheets, a design database of design representations corresponding to a plurality of predefined designs to be printed on at least one pre-cut sticker on a blank sticker sheet, and a sticker design application; receiving a user selection, on the host computer system, of a selected predefined sticker layout from the plurality of predefined sticker layouts; causing a sticker layout representation corresponding to the selected predefined sticker layout to be displayed on a user computer display; receiving a user selection, on the host computer system, of at least one selected predefined design from the plurality of predefined designs; causing a design representation corresponding to the at least one selected predefined design to be displayed on the user computer display superimposed on the sticker layout representation corresponding to the selected predefined sticker layout in response to the user selection; and causing the selected predefined design to be printed on the at least one pre-cut sticker on the blank sticker sheet.

Consistent with another embodiment, a computer-implemented system is provided for customizing and printing custom designed stickers. The system includes a sticker sheet database of predefined sticker layout representations corresponding to a plurality of predefined sticker layouts on blank sticker sheets including at least one pre-cut sticker and a design database of predefined design representations corresponding to a plurality of predefined designs to be printed on at least one pre-cut sticker on a blank sticker sheet. The system also includes a sticker design application configured to receive a user selection of a selected predefined sticker layout, to cause display of at least one of the sticker layout representations corresponding to the selected predefined sticker layout, to receive a user selection of at least one selected predefined design, to cause display of at least one of the design representations corresponding to the selected predefined design superimposed on the selected predefined sticker layout, and to cause the selected predefined design to be printed on at least one pre-cut sticker on a blank sticker sheet having a sticker layout corresponding to the selected predefined sticker layout.

Consistent with a further embodiment, there is provided a tangible computer-readable medium comprising instructions stored thereon, which when executed by a computer, cause the computer to perform the following operations: receiving a user selection of a selected predefined sticker layout from the plurality of predefined sticker layouts; causing a sticker layout representation corresponding to the selected predefined sticker layout to be displayed on a user computer display; receiving a user selection of at least one selected predefined design from the plurality of predefined designs; causing a design representation corresponding to the at least one selected predefined design to be displayed on the user computer display superimposed on the sticker layout representation corresponding to the selected predefined sticker layout in response to the user selection; and causing the selected predefined design to be printed on the at least one pre-cut sticker on the blank sticker sheet.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A method for customizing and printing custom designed stickers, the method comprising:
providing at least one blank sticker sheet at store locations, the blank sticker sheet including at least one pre-cut sticker in a predefined sticker layout;
providing access to a computer-implemented sticker designing system on a host computer system, the computer-implemented sticker designing system including a sticker sheet database of sticker layout representations corresponding to a plurality of predefined sticker layouts on blank sticker sheets, a design database of design representations corresponding to a plurality of predefined designs to be printed on at least one pre-cut sticker on a blank sticker sheet, and a sticker design application;
receiving a user selection, on the host computer system, of a selected predefined sticker layout from the plurality of predefined sticker layouts;
causing a sticker layout representation corresponding to the selected predefined sticker layout to be displayed on a user computer display;
receiving a user selection, on the host computer system, of at least one selected predefined design from the plurality of predefined designs;
causing a design representation corresponding to the at least one selected predefined design to be displayed on the user computer display superimposed on the sticker layout representation corresponding to the selected predefined sticker layout in response to the user selection; and
causing the selected predefined design to be printed on the at least one pre-cut sticker on the blank sticker sheet.

2. The method of claim 1 wherein each of the predefined sticker layouts is associated with an identifier, wherein the sticker sheet database includes identifiers associated with the sticker layout representations, and wherein receiving the user selection of the selected predefined sticker layout includes receiving an identifier identifying the selected predefined sticker layout.

3. The method of claim 2 further comprising causing identifiers identifying the predefined sticker layouts to be displayed on the user computer display for selection by the user.

4. The method of claim 1 further comprising causing the design representations corresponding to the plurality of predefined designs to be displayed on the computer display for selection by the user.

5. The method of claim 1 wherein the blank sticker sheet includes alphanumeric stickers, and wherein at least one of the predefined sticker layouts includes an arrangement of alphanumeric shapes matching the alphanumeric stickers on the blank sticker sheet.

6. The method of claim 1 wherein the blank sticker sheet includes stickers having different shapes, and wherein at least one of the predefined sticker layouts includes a plurality of different shapes matching the different shapes of the stickers on the blank sticker sheet.

7. The method of claim 1 wherein the predefined designs include at least one of colors and patterns.

8. The method of claim 1 wherein the selected predefined design is printed on the at least one pre-cut sticker such that the selected predefined design fills only the at least one pre-cut sticker.

9. The method of claim 1 further comprising receiving at least one uploaded user design.

10. The method of claim 9 wherein the predefined designs include the uploaded user design.

11. The method of claim 1 wherein providing access to the computer-implemented sticker designing system includes providing access via a remote user terminal including the user computer display.

12. The method of claim 11 wherein causing the selected design to be printed on the blank sticker sheet includes sending a print command to a printer coupled to the remote user terminal.

13. The method of claim 1 wherein providing access to the computer-implemented sticker designing system includes providing access via a user terminal at the store location including the user computer display, and wherein causing the selected design to be printed on the blank sticker sheet includes sending a print command to a printer coupled to the user terminal at the store location.

14. The method of claim 1 wherein providing access to the computer-implemented sticker design system includes establishing a web site for accessing the sticker sheet database, the design database, and the sticker design application.

15. The method of claim 1 further comprising:
tracking the selected sticker layouts and the selected predefined designs that users select for printing; and
determining popular custom designed stickers based on the selected sticker layouts and the selected predefined designs that are tracked.

16. A computer-implemented system for customizing and printing custom designed stickers, the system comprising:
a sticker sheet database of predefined sticker layout representations corresponding to a plurality of predefined sticker layouts on blank sticker sheets including at least one pre-cut sticker;
a design database of predefined design representations corresponding to a plurality of predefined designs to be printed on at least one pre-cut sticker on a blank sticker sheet; and
a sticker design application configured to receive a user selection of a selected predefined sticker layout, to cause display of at least one of the sticker layout representations corresponding to the selected predefined sticker layout, to receive a user selection of at least one selected predefined design, to cause display of at least one of the design representations corresponding to the selected predefined design superimposed on the selected predefined sticker layout, and to cause the selected predefined design to be printed on at least one pre-cut sticker on a blank sticker sheet having a sticker layout corresponding to the selected predefined sticker layout.

17. The system of claim 16 wherein the sticker sheet database includes identifiers associated with the sticker layout representations, and wherein the sticker design application is configured to receive an identifier identifying one of the sticker layout representations.

18. The system of claim 16 wherein the sticker design application includes at least one web page.

19. The system of claim 16 wherein the sticker design application is configured to receive an upload of a user design.

20. A tangible computer-readable medium comprising instructions stored thereon, which when executed by a computer, cause the computer to perform the following operations:
receiving a user selection of a selected predefined sticker layout from the plurality of predefined sticker layouts;
causing a sticker layout representation corresponding to the selected predefined sticker layout to be displayed on a user computer display;
receiving a user selection of at least one selected predefined design from the plurality of predefined designs;
causing a design representation corresponding to the at least one selected predefined design to be displayed on the user computer display superimposed on the sticker layout representation corresponding to the selected predefined sticker layout in response to the user selection; and
causing the selected predefined design to be printed on the at least one pre-cut sticker on the blank sticker sheet.
